(19) United States
(12) Patent Application Publication
(10) Pub. No.: US 2015/0056973 A1
(43) Pub. Date: Feb. 26, 2015

(54) USING VEHICLE DATA TO MAKE CALL TERMINATION DECISIONS

(71) Applicant: Vonage Network LLC, Holmdel, NJ (US)

(72) Inventor: Tzahi Efrati, Hoboken, NJ (US)

(73) Assignee: Vonage Network LLC, Holmdel, NJ (US)

(21) Appl. No.: 13/972,982

(22) Filed: Aug. 22, 2013

(51) Int. Cl. H04W 76/06; H04M 1/725

(52) U.S. Cl. CPC H04W 76/064; H04M 1/72577
USPC 455/418

(57) ABSTRACT

A method and apparatus for terminating a call directed to a mobile device using vehicle operating information. In some embodiments, the method may include receiving a call request to establish a call with the mobile device, selecting a call termination procedure based on the vehicle operating information, and causing the call to be terminated using the selected call termination procedure.

### BACKGROUND

1. Field

Embodiments of the present invention relate generally to communication systems and, more particularly, to methods and apparatus for using vehicle data to make call termination decisions.

2. Description of the Related Art

The operating environment that a mobile device, and an end-user of the mobile device, may be subject to while in a moving vehicle may change considerably over time. For example, mobile telecommunication network coverage may change as the vehicle moves through various urban and rural areas. Although a wireless mobile telecommunication signal may be strong in some locations, it may not be strong in others causing calls to drop even when other wireless network connections may be available.

In addition, vehicle operators may be engaged in driving related activities that would create an unsafe driving condition if they attempted to handle an incoming call, regardless of whether the mobile device could be used “hands-free”. Distracted driving is the act of driving while engaged in other activities—such as using a cell phone, texting, eating, or reading—which take the driver's attention away from the road. Distractions influenced by technology, especially text messaging or talking on the phone, require a combination of visual, manual, and cognitive attention from the driver, thus making these types of distractions particularly dangerous.

In view of the foregoing, there exists a need in the art for a method and apparatus for considering additional criteria, such as the availability of information relating to the vehicle operating environment, to enable more intelligent call termination decisions.

### SUMMARY

A method and apparatus for terminating a call directed to a mobile device using vehicle operating information. In some embodiments, the method may include receiving a call request to establish a call with the mobile device, selecting a call termination procedure based on the vehicle operating information, and causing the call to be terminated using the selected call termination procedure.

In some embodiments, a system for terminating a call directed to a mobile device using vehicle operating information may include a vehicle interface module configured to obtain vehicle operating information from a vehicle interface device, a call route selection module configured to select a call termination procedure based on the vehicle operating information obtained, and a routing module configured to terminate the call using the selected call termination procedure.

In some embodiments, an apparatus for terminating a call directed to a mobile device using vehicle operating information may include at least one processor, at least one input device, and at least one storage device storing processor executable instructions which, when executed by the at least one processor, performs a method including receiving a call request to establish a call with the mobile device, selecting a call termination procedure based on the vehicle operating information, and terminating the call using the selected call termination procedure.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a telecommunication network in accordance with embodiments consistent with the present application;

FIG. 2A depicts a flow diagram of a general method for terminating calls based upon vehicle operating conditions, according to one or more embodiments of the invention;

FIG. 2B depicts a flow diagram of a detailed method for terminating calls to a mobile device located in a vehicle based upon vehicle operating conditions, according to one or more embodiments of the invention; and

FIG. 3 is a detailed block diagram of a computer system, according to one or more embodiments.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention relate generally to communication systems and, more particularly, to methods and apparatus for making call termination decisions based on a mobile device's operating environment. Specifically, efforts have been made to create intelligent vehicles, based on advances made in the mobile device area. In embodiments consistent with the present invention, the availability of information relating to these intelligent vehicles enables more intelligent call termination decisions based on a mobile device's operating environment (e.g., driving conditions and/or expected call conditions) that may be determined using the vehicle information. As used herein, call termination (i.e., telecommunication session termination) refers to the routing of telephone calls from one end-user device to another via one or more telecommunication service providers.

For example, in some embodiments, vehicle operating information, in combination with information derived from other sources such as navigation or weather apps, may permit the determination of driving conditions (actual or inferred) that can determine whether a driver be too distracted to handle an incoming call. In addition, expected call conditions may be used in deciding how to terminate the call. For example, the type and strength of mobile wireless coverage that is currently available to a mobile device in a moving vehicle, type and strength of mobile wireless coverage that will be available down the road, may be used in deciding how to terminate the call. Based on these determinations, decisions for handling current or incoming calls may be made, such as, for example whether and when the call should be connected, how the call should be connected, whether the call should be handed-off. These and further embodiments of the present invention are described below in more detail.

Some portions of the detailed description which follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “selecting”, “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. The following detailed description of preferred embodiments refers to the accompanying drawings, which illustrate specific embodiments of the invention. Other embodiments having different structures and operations do not depart from the scope of the present invention.

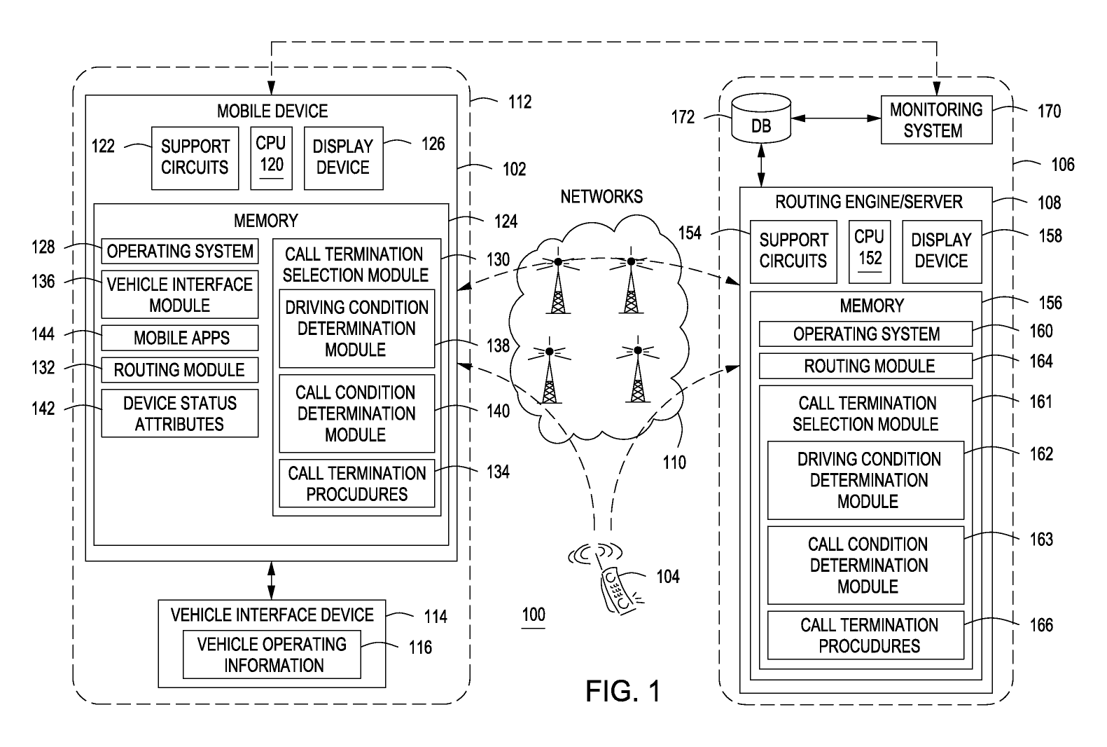

FIG. 1 depicts a block diagram of a system 100 for terminating a call using vehicle operating information of a vehicle in which a mobile device associated with a driver of the vehicle is located. The system 100 includes at least one telecommunication service provider network 106 that can provide telecommunication services to a plurality of end-user devices (e.g., such as mobile devices 102 and 104) via one or more networks 110.

The end-user device (e.g., mobile device 102) comprises a Central Processing Unit (CPU) 120, support circuits 122, memory 124, and the display device 126. The CPU 120 may comprise one or more commercially available microprocessors or microcontrollers that facilitate data processing and storage. The various support circuits 122 facilitate the operation of the CPU 120 and include one or more clock circuits, power supplies, cache, input/output circuits, and the like. The memory 124 comprises at least one of Read Only Memory (ROM), Random Access Memory (RAM), disk drive storage, optical storage, removable storage and/or the like. In some embodiments, the memory 124 comprises an operating system 128, call termination selection module 130, routing module 132, vehicle interface module 136, device status attributes 142, and mobile apps 144. In some embodiments, call termination selection module 130 includes call termination procedures 134, driving condition determination module 138, and call condition determination module 140.

The operating system (OS) 128 generally manages various computer resources (e.g., network resources, file processors, and/or the like). The operating system 128 is configured to execute operations on one or more hardware and/or software modules, such as Network Interface Cards (NICs), hard disks, virtualization layers, firewalls and/or the like. Examples of the operating system 128 may include, but are not limited to, LINUX, MAC OSX, BSD, UNIX, MICROSOFT WINDOWS, IOS, ANDROID and the like.

The telecommunication service provider network 106 may include a routing engine 108, a routing information database 172, and a network monitoring system 170. In some embodiments, the routing engine 108 determines/selects the network routes for establishing a telecommunication connection between end user devices (e.g., mobile devices 102 and 104), and routes the telecommunication traffic accordingly. The routing engine 108 comprises a Central Processing Unit (CPU) 152, support circuits 154, memory 156, and, in some embodiments, an optional display device 158. The CPU 152 may comprise one or more commercially available microprocessors or microcontrollers that facilitate data processing and storage. The various support circuits 154 facilitate the operation of the CPU 152 and include one or more clock circuits, power supplies, cache, input/output circuits, and the like. The memory 156 comprises at least one of Read Only Memory (ROM), Random Access Memory (RAM), disk drive storage, optical storage, removable storage and/or the like. In some embodiments, the memory 156 comprises an operating system 160, call termination selection module 161 and a routing module 164. In some embodiments, call termination selection module 161 includes call termination procedures 166, driving condition determination module 162, and call condition determination module 163.

The routing engine OS 160 generally manages various computer resources (e.g., network resources, file processors, and/or the like). The operating system 160 is configured to execute operations on one or more hardware and/or software modules, such as Network Interface Cards (NICs), hard disks, virtualization layers, firewalls and/or the like. Examples of the operating system 160 may include, but are not limited to, LINUX, MAC OSX, BSD, UNIX, MICROSOFT WINDOWS, IOS, ANDROID and the like.

The networks 110 comprise one or more communication systems that connect computers by wire, cable, fiber optic and/or wireless link facilitated by various types of well-known network elements, such as hubs, switches, routers, and the like. The networks 110 may include an Internet Protocol (IP) network, a public switched telephone network (PSTN), or other mobile communication networks, and may employ various well-known protocols to communicate information amongst the network resources.

In embodiments consistent with the present invention, mobile device 102 may be located in, or otherwise associated with, a vehicle 112. For example, the mobile device 102 may belong to, or otherwise be associated with, a driver or passenger of vehicle 112. In some embodiments, the mobile device 102 may be communicatively coupled to the vehicle 112 using vehicle interface module 136 on mobile device 102 and vehicle interface device 114 on vehicle 112. For example, in some embodiments, the mobile device 102 may be coupled to vehicle interface device 114 via BLUETOOTH, WI-FI, or other type of wireless or wired communication method. In some embodiments, mobile device 102 may be coupled to an onboard diagnostic port or a Universal Serial Bus (USB) port on the vehicle. In some embodiments, some vehicles may include a SIM card and may be able to make/receive calls directly without the use of a separate mobile device 102. In some embodiments, the vehicle interface device 114 supports or includes hardware and/or software application programming interfaces (API) for accessing vehicle operating information 116 of the vehicle. Vehicle interface module 136 may obtain vehicle operating information 116 by making API calls.

One example of a hardware and software API that may be included in vehicle interface device 114 is OPENXC. OPENXC is an open source hardware and software API created by FORD MOTOR COMPANY and other participants. OPENXC provides a number of vehicle measurement/operating parameters that application developers may use to provide functionality to end-users.

Non-limiting examples of vehicle operating information 116 that may be stored in, or accessed by, vehicle interface device 114 may include accelerator pedal position, whether the brake or parking brake is being pressed or engaged (e.g., brake pedal position and/or braking status), engine speed, fuel consumption data (e.g., fuel consumed since vehicle was started), current fuel remaining, whether headlights or high beams are on or off, geolocation information (e.g., GPS latitude and longitude), odometer reading, angle of the steering wheel, whether a door is open or closed, whether a mobile device is connected “hands free” via the vehicle, vehicle speed, proximity sensors the provide proximity data of external objects, status of turn signals or windshield wipers, and the like.

The vehicle operating information 116 obtained may be used to select a call termination procedure based on the vehicle operating information 116. For example, in some embodiments, a call termination selection module 130 disposed on mobile device 102 may be used to select a call termination procedure based on the vehicle operating information 116. In other embodiments, the vehicle operating information 116 may be obtained by routing engine 108 via monitoring system 170. In some embodiments the vehicle operating information 116 obtained is stored in database 172. Call termination selection module 161 may be used to select a call termination procedure based on the vehicle operating information 116 obtained.

In some embodiments, the vehicle operating information 116 obtained may be used to decide how to terminate a call based on driving conditions determined. Specifically, there are safe and unsafe times to direct a call to a vehicle-operating recipient (e.g., the driver). For example, if the driver is on local roads with constantly-changing conditions (e.g., stop lights, potential pedestrians, frequent turns), it may be distracting or unsafe to receive an incoming call. On the other hand, if the driver is in relatively constant conditions (e.g., on a highway with relatively light traffic), then it may be relatively more safe and convenient to receive an incoming call.

In some embodiments, driving conditions may be determined by mobile device 102 using driving condition determination module 138, or by driving condition determination module 162. For example, driving condition determination module 138 may include logic that analyzes vehicle operating information 116 to infer existing driving conditions. For example, driving condition determination module 138 may determine that the vehicle 112 is on a highway or on cruise control because the speed over a recent time period has remained relatively constant, or may determine that the vehicle is on local roads with constantly-changing conditions (e.g., stop lights, potential pedestrians, frequent turns, etc.). Other driving conditions that may be determined include determining that it is dark based on headlight usage (e.g., high beams on may indicate very dark rural conditions), it is raining based on wind shield wiper usage, that the user may be in an unfamiliar neighborhood based on GPS usage or based on high frequency of turns (e.g., U-Turns), whether the vehicle is currently turning based on whether the steering wheel angle has exceeded a threshold limit in a recent time period, etc. In some embodiments, driving conditions may be inferred by analyzing a recent history of vehicle speed in conjunction with other data. For example, if a driver activates the turn signal, but vehicle speed remains constant, it may be inferred that the driver is switching lanes and thus may still be able to accept or make a call. If, for example, the vehicle begins to slow down in conjunction with the turn signal activation, it may be inferred that the driver is about to make a turn and should not be distracted (e.g., driver not able to accept a call request or make a call.). In some embodiments, if the drivers recent speed history shows a significant slow down, it may be inferred that the driver is no longer on a highway, or is in traffic. Based on user preferences set by the driver, the system may allow the calls to be terminated or not terminated under any of the conditions described above.

In some embodiment, the vehicle operating information 116 obtained may also be used to decide how to terminate a call based on current and expected call conditions. Call conditions may be determined using call condition determination module 140, or by call condition determination module 163. For example, in some embodiments, call condition determination module 140 can predict when and where along a driver's route cell or data coverage may be expected to deteriorate or fail. The vehicle operating information 116 that may be used to determine current and expected call condition include, the vehicle route which may be obtained from Navigation/GPS information, vehicle speed, current traffic conditions (may be determined by detecting speed of other vehicles on route, or through information provided over radio), expected traffic (may be based on historical data, in relation to factors such as day of the week or the time of day), the availability of mobile wireless sources to the mobile device 102, signal strength of those mobile wireless sources on the route (e.g., OPENSIGNAL provides crowd-sourced coverage maps within the U.S.), whether a mobile device is in a “hands free” mode, and the like. Based on the expected speed and the route (taking into account, for example, traffic), the vehicle's position on the route at any given time may be estimated. Then, based on the available mobile telecommunication coverage data, it may be determined at what times mobile device 102 located in vehicle 112 will have insufficient or less-than-ideal coverage to make a phone call. This data may be updated in real-time, as speed, location, traffic and route change.

In some embodiments, information used to determine driving conditions and/or call conditions may be derived from one or more of a navigation device, mobile apps 144 (e.g., a navigation app, a weather app, etc.), device accelerometer data, mobile telecommunication network sign strength data sources, or device attributes 142 of mobile device 102. In some embodiments, device attributes 142 may include at least one of Quality of Service (QoS) information for communication connections available, geolocation information of the first device, cost for using communication connections available, battery level of the first device, external noise that will affect how the driver or caller will be heard, temperature in the car and the like.

Based on the above determinations, and on whether or not the driver can safely accept the call, or place a call, call connection decisions may be made. That is, for example, the call termination selection module 130 may use results from the driving condition determination module 138, and/or the call condition determination module 140, to select a call termination procedure 134 for the call. Similarly, if the vehicle operating information 116 is sent to routing engine 108 for analysis, the call termination selection module 161 may use results from the driving condition determination module 162, and/or the call condition determination module 163, to select a call termination procedure 166 for the call. For example, in some embodiments, if the driver is currently in a situation not suited to safely accepting incoming calls, the caller (e.g., the caller user device 104) may be directed to call back later. In some embodiments, the caller user device 104 may be given instructions to schedule the call at a later time. If trip route data is available, then based on location and speed of the vehicle 112 (and thus mobile device 102), the caller may be told when to call back. In some embodiments, the caller may also be given other information, such as the reason that the call is not being connected (e.g., driver currently experiencing difficult driving conditions.) Alternatively, the system may provide for an automatic call back be made to the caller when the recipient has reached an area where conditions have improved.

Additional call termination procedures 134/166 may include how to handle an existing call if it appears like the driver will be entering an area where coverage is unavailable (such as an underground tunnel). In such a situation, it may be helpful to notify the parties before the connection drops, including the approximate remaining time before the call drops, based on location, speed and route data. Alternatively, it may be useful to proactively initiate a handoff to another wireless source (such as a Wi-Fi router accessible from inside the tunnel), even before signal strength begins to deteriorate. Again, the participants (e.g., the driver associated with mobile device 102 and the end-user associated with mobile device 104) may be told when to expect coverage to be available again, and may initiate a call back when coverage is available. Each of the foregoing call termination procedures 134/166 may be default values, configured by a user associated with the call termination procedures, or determined on-the-fly by call termination selection modules 130, 161 based on the driving conditions and/or call conditions.

In some embodiments, after a call termination procedure 134/166 is selected, routing module 164 will route (i.e., terminate) the call as indicated in the selected call termination procedure 134/166. In some embodiments, routing module 132 will route (i.e., terminate) the call as indicated in the selected call termination procedure 134/166.

In the foregoing embodiments, much of the discussion was focused on receiving call requests directed to a mobile device located in a vehicle (such as mobile device 102 located in vehicle 112) and whether a user of the mobile device could safely accept the call. However, in some embodiments, the system 100 shown in FIG. 1 can also be used in situations where mobile device 102 is attempting to place a call to another telecommunication device such as a mobile device 104. For example, the system 100 may recommend the driver wait before making a call since the weather will clear in a few miles, or the vehicle is about to enter a no-coverage area. The driver's mobile device 102 may be instructed to schedule a call at a later time under those or similar conditions. Similar to the embodiments discussed above regarding termination decision upon receive a call request to mobile device 102, in some embodiments, the call termination selection module 130/161 can predict when and where during a driver's trip cell or data coverage may be expected to deteriorate or fail. The call termination selection module 130/161 may use the vehicle's location, current route, expected speed over the route, the available mobile wireless sources (generally, mobile carrier networks that are available to a user, and coverage of those mobile wireless sources on the user's route. Expected speed may be determined using current vehicle speed, current traffic conditions over the route (e.g., may be determined by looking at speed of other vehicles on route, or through information provided over radio), expected traffic and speed (e.g., may be based on historical data, in relation to factors such as day of the week or the time of day). Based on the expected speed and the vehicle route, the driver's position on the route at any given time may be estimated. Then, based on the available coverage data, it may be determined at what times the driver will have insufficient coverage to make a phone call. The system 100 may recommend the driver wait (e.g., by issuing a warning indication) before making a call since the weather will clear in a few miles, or the vehicle is about to enter a no-coverage area. In some embodiments, depending on the preferences set by the user of mobile device 102, for example, the mobile device 102 may prevent the driver from making a call based on existing or expected calling/driving conditions.

In some embodiments, a quantifiable driver index may be calculated using the vehicle operating information in the determined driving conditions. The quantifiable driver index may indicate a level of distraction of the driver. If the quantifiable driver index is over a certain threshold value, then no calls will be authorized to be terminated to the mobile device of the driver.

In some embodiments, the call termination selection module 130/161 may include parental control features that allow a parent to set the call terminations procedures. A password may be used to secure the call termination procedures from being changed by an unauthorized user. For example, a parent may wish to set the call termination procedures such that mobile device 102 is not permitted to accept or place any calls while the vehicle is in motion.

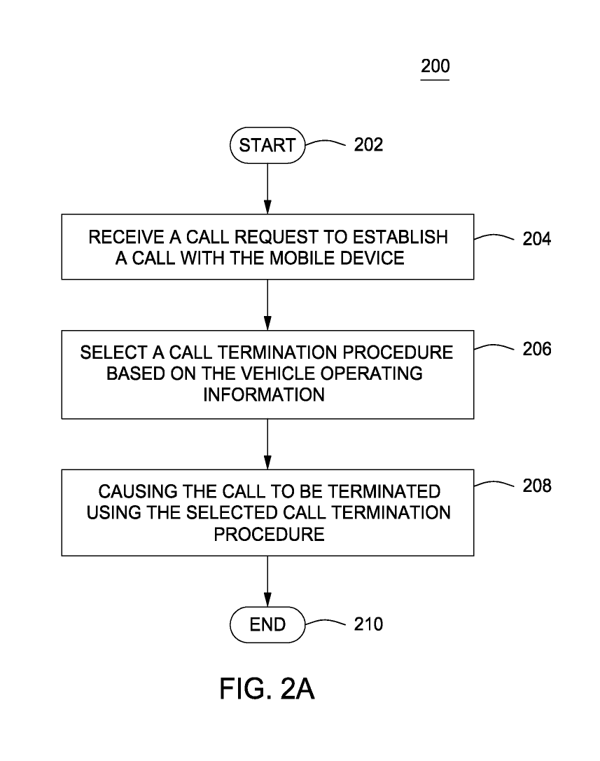

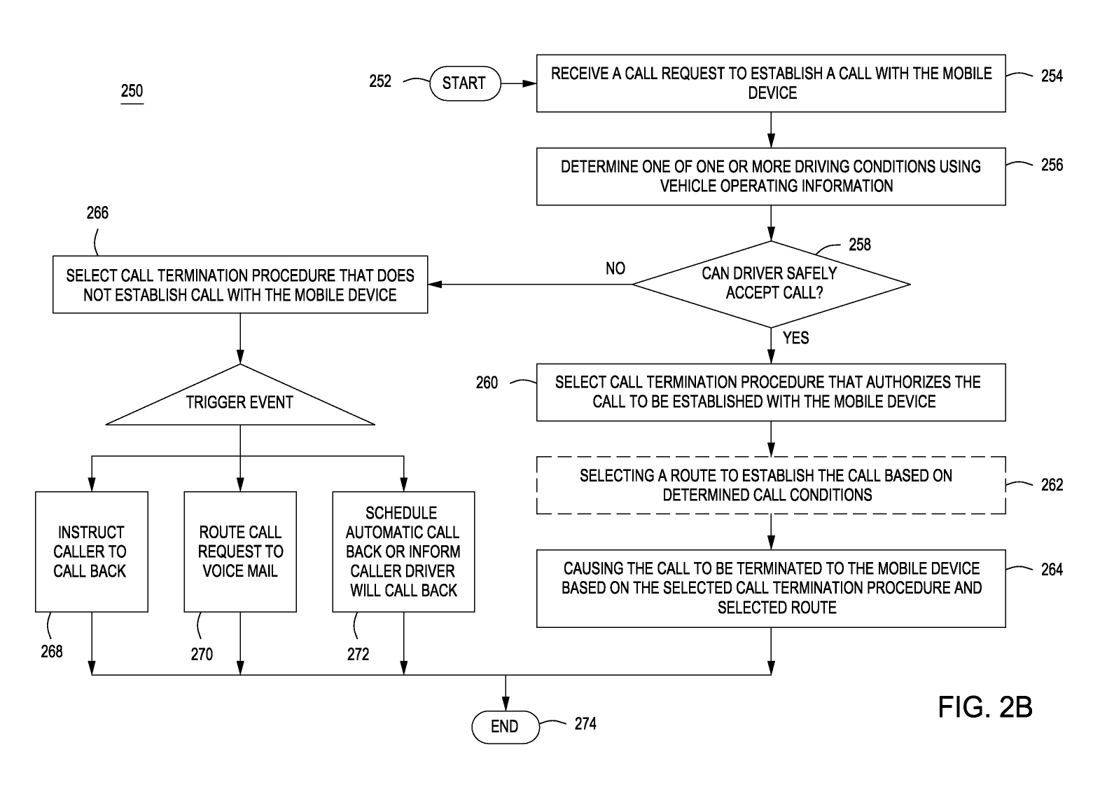

A method 200 in accordance with the subject invention is illustrated in FIG. 2A which depicts a flowchart having a series of steps for terminating a call using vehicle operating information. In some embodiments, the method 200 may be entirely performed by the routing engine 108. In other embodiments, the method 200 may be entirely performed by a mobile device (e.g., mobile device 102). Still in other embodiments, portions of the method 200 may be performed by the routing engine 108, while other portions are performed by a mobile device 102.

In detail, the method 200 starts at 202 and proceeds to 204 where a call request to establish a call with a mobile device is received. In some embodiments, the call request may be originated by a telecommunication device such as, for example, mobile device 104 in FIG. 1. In some embodiments, the call request may be directed to a telecommunication device such as for example mobile device 102 located in a vehicle 112. In other embodiments, the call request may be originated by a mobile device 102 located in vehicle 112, and the directed to another telecommunication device such as mold device 104.

At 206 a call termination procedure may be selected based on vehicle operating information. The vehicle operating information (e.g., vehicle operating information 116) may be obtained as described above with respect to FIG. 1. In some embodiments, the step of selecting a call termination procedure based on the vehicle operating information may include determining one or more driving conditions using the vehicle operating information and then selecting the call termination procedure based on the determined one or more driving conditions. In addition, selecting the call termination procedure may further include determining whether or not the driver associated with the mobile device, such as mobile device 102, can safely accept the call based on the determined one or more driving conditions. The determination whether or not the driver can safely accept the call is based on one or more of the speed of the vehicle, steering wheel position, headlight usage, windshield wiper usage, geolocation information, turn signal information, time of day, and the like.

Some exemplary call termination procedures may include, but are not limited to, authorizing the call to be established with the mobile device, instructing the caller to call back at another time, routing the call request to a voice mail system, scheduling an automatic call back when the driver becomes available or in a position to safely participate a call, or informing the caller that the driver will call back at a later time.

At 208 the call is terminated (i.e., routed), or caused to be terminated, using the selected call termination procedure. The method 200 ends at 210.

A method 250 in accordance with the subject invention is illustrated in FIG. 2B which depicts another flowchart having a series of steps for terminating a call using vehicle operating information. In some embodiments, the method 250 may be entirely performed by the routing engine 108. In other embodiments, the method 250 may be entirely performed by a mobile device (e.g., mobile device 102). Still in other embodiments, portions of the method 250 may be performed by the routing engine 108, while other portions are performed by a mobile device 102.

In detail, the method 250 starts at 252 and proceeds to 254 where a call request to establish a call with a mobile device is received. In embodiments consistent with FIG. 2B, the call request is originated by a telecommunication device such as, for example, mobile device 104, and is direct to mobile device 102 located in vehicle 112. At 256, one or more driving conditions using the vehicle operating information obtained is determined responses to the call request is received. At 258, if it is determined that the driver can safely accept the call, then a call termination procedure authorizes the call to be established with the mobile device 102 is selected at step 260. In some embodiments, call conditions, or expected call conditions, may optionally be determined and used in selecting a route to establish the call to mobile device 102 at 262. At 264, the call is terminated, or caused to be terminated, at the mobile device 202 based on the selected call termination procedure in the selected route. The method 250 ends at 274.

If, at 258, if it is determined that the driver cannot safely accept the call, a call termination procedure that does not establish the call with the mobile device is selected at 266. Some exemplary call termination procedures that do not establish the call with the mobile device may include, for example, but are not limited to, instructing the caller to call the driver back at a later time (step 268), routing the call request to the driver's voice mail system (step 270), scheduling an automatic call back forming the caller that the driver will call them back (272), and the like. The method 250 ends at 274.

The embodiments of the present invention may be embodied as methods, apparatus, electronic devices, and/or computer program products. Accordingly, the embodiments of the present invention may be embodied in hardware and/or in software (including firmware, resident software, micro-code, and the like), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus or device. More specific examples (a non exhaustive list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

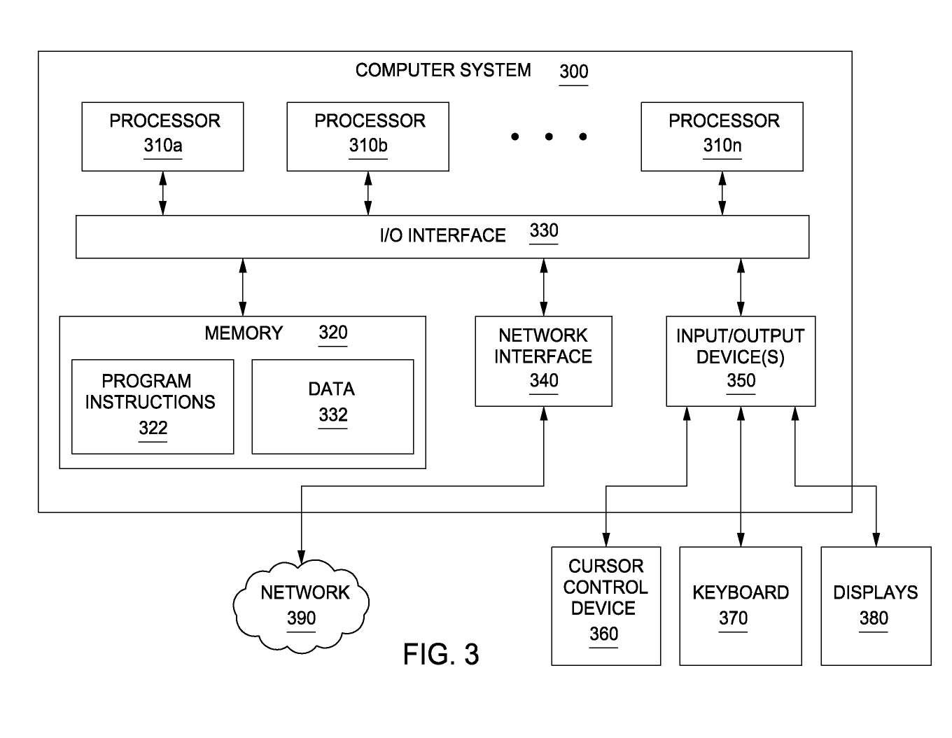

FIG. 3 depicts a computer system 300 that can be utilized in various embodiments of the present invention to implement the computer and/or the display, according to one or more embodiments.

Various embodiments of method and apparatus for routing calls based upon internal network conditions and/or external carrier network information, as described herein, may be executed on one or more computer systems, which may interact with various other devices. One such computer system is computer system 300 illustrated by FIG. 3, which may in various embodiments implement any of the elements or functionality illustrated in FIGS. 1, 2A and 2B. In various embodiments, computer system 300 may be configured to implement methods described above. The computer system 300 may be used to implement any other system, device, element, functionality or method of the above-described embodiments. In the illustrated embodiments, computer system 300 may be configured to implement methods 200 and 250 as processor-executable executable program instructions 322 (e.g., program instructions executable by processor(s) 310) in various embodiments.

In the illustrated embodiment, computer system 300 includes one or more processors 310a-310n coupled to a system memory 320 via an input/output (I/O) interface 330. Computer system 300 further includes a network interface 340 coupled to I/O interface 330, and one or more input/output devices 350, such as cursor control device 360, keyboard 370, and display(s) 380. In various embodiments, any of the components may be utilized by the system to receive user input described above. In various embodiments, a user interface may be generated and displayed on display 380. In some cases, it is contemplated that embodiments may be implemented using a single instance of computer system 300, while in other embodiments multiple such systems, or multiple nodes making up computer system 300, may be configured to host different portions or instances of various embodiments. For example, in one embodiment some elements may be implemented via one or more nodes of computer system 300 that are distinct from those nodes implementing other elements. In another example, multiple nodes may implement computer system 300 in a distributed manner.

In different embodiments, computer system 300 may be any of various types of devices, including, but not limited to, personal computer systems, mainframe computer systems, handheld computers, workstations, network computers, application servers, storage devices, a peripheral devices such as a switch, modem, router, or in general any type of computing or electronic device.

In various embodiments, computer system 300 may be a uniprocessor system including one processor 310, or a multiprocessor system including several processors 310 (e.g., two, four, eight, or another suitable number). Processors 310 may be any suitable processor capable of executing instructions. For example, in various embodiments processors 310 may be general-purpose or embedded processors implementing any of a variety of instruction set architectures (ISAs). In multiprocessor systems, each of processors 310 may commonly, but not necessarily, implement the same ISA.

System memory 320 may be configured to store program instructions 322 and/or data 332 accessible by processor 310. In various embodiments, system memory 320 may be implemented using any suitable memory technology, such as static random access memory (SRAM), synchronous dynamic RAM (SDRAM), non-volatile/Flash-type memory, or any other type of memory. In the illustrated embodiment, program instructions and data implementing any of the elements of the embodiments described above may be stored within system memory 320. In other embodiments, program instructions and/or data may be received, sent or stored upon different types of computer-accessible media or on similar media separate from system memory 320 or computer system 300.

In one embodiment, I/O interface 330 may be configured to coordinate I/O traffic between processor 310, system memory 320, and any peripheral devices in the device, including network interface 340 or other peripheral interfaces, such as input/output devices 350. In some embodiments, I/O interface 330 may perform any necessary protocol, timing or other data transformations to convert data signals from one component (e.g., system memory 320) into a format suitable for use by another component (e.g., processor 310). In some embodiments, I/O interface 330 may include support for devices attached through various types of peripheral buses, such as a variant of the Peripheral Component Interconnect (PCI) bus standard or the Universal Serial Bus (USB) standard, for example. In some embodiments, the function of I/O interface 330 may be split into two or more separate components, such as a north bridge and a south bridge, for example. Also, in some embodiments some or all of the functionality of I/O interface 330, such as an interface to system memory 320, may be incorporated directly into processor 310.

Network interface 340 may be configured to allow data to be exchanged between computer system 300 and other devices attached to a network (e.g., network 390), such as one or more external systems or between nodes of computer system 300. In various embodiments, network 390 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 340 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 350 may, in some embodiments, include one or more display terminals, keyboards, keypads, touchpads, scanning devices, voice or optical recognition devices, or any other devices suitable for entering or accessing data by one or more computer systems 300. Multiple input/output devices 350 may be present in computer system 300 or may be distributed on various nodes of computer system 300. In some embodiments, similar input/output devices may be separate from computer system 300 and may interact with one or more nodes of computer system 300 through a wired or wireless connection, such as over network interface 340.

In some embodiments, the illustrated computer system may implement any of the methods described above, such as the methods illustrated by the flowchart of FIGS. 2A and 2B. In other embodiments, different elements and data may be included.

Those skilled in the art will appreciate that computer system 300 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 300 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 300 may be transmitted to computer system 300 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A method for terminating a call directed to a mobile device using vehicle operating information comprising:
receiving a call request to establish a call with the mobile device;
selecting a call termination procedure based on the vehicle operating information; and
causing the call to be terminated using the selected call termination procedure.

2. The method of claim 1, wherein the vehicle operating information includes at least one of accelerator pedal position, brake pedal position, braking status, engine speed, fuel consumption data, current fuel remaining, headlight information, geolocation information, odometer reading, angle of the steering wheel, door position, vehicle speed, proximity information of external objects, turn signal status, or windshield wiper status.

3. The method of claim 1, wherein the vehicle operating information is obtained via at least one Application Programming Interface (API) call to vehicle interface module.

4. The method of claim 1, wherein the vehicle operating information is provided wirelessly from a vehicle interface module to the mobile device.

5. The method of claim 1, wherein selecting the call termination procedure includes:
determining one or more driving conditions using the vehicle operating information; and
selecting the call termination procedure based on the determined the one or more driving conditions.

6. The method of claim 5, wherein selecting the call termination procedure further includes determining whether or not a driver associated with the mobile device can safely accept the call based on the determined one or more driving conditions.

7. The method of claim 6, wherein the determination whether or not the driver can safely accept the call is based on at least one of (a) speed of the vehicle, (b) steering wheel position, (c) headlight usage, (d) windshield wiper usage, (e) geolocation information, (f) turn signal information, or (g) time of day.

8. The method of claim 5, wherein selecting the call termination procedure further includes determining that a driver associated with the mobile device can safely accept the call based on determined driving conditions, and wherein the selected call termination procedure authorizes the call to be established with the mobile device.

9. The method of claim 5, wherein selecting the call termination procedure further includes determining that a driver associated with the mobile device cannot safely accept the call based on determined driving conditions, and wherein the selected call termination procedure includes at least one of (a) instructing a caller to call back at another time, (b) routing the call to a voice mail system, (c) informing a caller that a driver associated with the mobile device will call the caller back, or (d) scheduling an automatic call back to a caller.

10. The method of claim 5, wherein selecting the call termination procedure further includes selecting a route to establish the call based on determined call conditions.

11. The method of claim 10, wherein the call conditions are determined based on at least one of (a) route of the vehicle, (b) speed of the vehicle, (c) traffic conditions, (d) current wireless mobile network sources available, (e) anticipated wireless mobile network sources available along vehicle route, (f) signal strength of each wireless mobile network source available, or (g) time of day.

12. The method of claim 10, wherein the selected call termination procedure includes directing the call to be routed over a first wireless network, and wherein the call is terminated using the first wireless network.

13. The method of claim 12, further comprising:
determining a second set of call conditions;
selecting an alternate route over a second wireless network to transfer the call to based on the second set of call conditions; and
causing the call to be transferred to the selected alternate route such that the call is terminated using the second wireless network.

14. The method of claim 1, wherein the call termination procedure selected is further based on information derived from at least one of a navigation device, a navigation app, a weather app, device accelerometer data, mobile telecommunication network sign strength data sources, or device status attributes.

15. System for terminating a call directed to a mobile device using vehicle operating information comprising:
a vehicle interface module configured to communicatively couple with a vehicle interface device to obtain vehicle operating information from the vehicle interface device;
a call route selection module configured to select a call termination procedure based on the vehicle operating information obtained; and
a routing module configured to cause the call to be terminated using the selected call termination procedure.

16. The system of claim 15, wherein the call route selection module and the routing module are included in a routing engine on a service provider network.

17. The system of claim 15, wherein the call route selection module and the routing module are included on the mobile device.

18. The system of claim 15, wherein the vehicle operating information includes at least one of accelerator pedal position, brake pedal position, braking status, engine speed, fuel consumption data, current fuel remaining, headlight information, geolocation information, odometer reading, angle of a steering wheel, door position, vehicle speed, proximity information of external objects, turn signal status, or windshield wiper status.

19. The system of claim 15, further comprising:
a driving condition determination module configured to determine one or more driving conditions using the vehicle operating information; and
a call condition module configured to determine one or more expected call conditions using the vehicle operating information
wherein the call route selection module is configured to select a call termination procedure based on the determined at least one of the one or more driving conditions or the one or more expected call conditions.

20. A method for handling a call initiated from a mobile device in a vehicle using vehicle operating information comprising:
receiving a call initiation request from a user attempting to place a call from the mobile device in the vehicle;
selecting a call termination procedure based on the vehicle operating information; and
causing the call to be terminated using the selected call termination procedure.

21. The method of claim 20, wherein selecting the call termination procedure includes selecting a route to establish the call based on determined call conditions.

22. The method of claim 21, wherein the call conditions are determined based on at least one of (a) route of the vehicle, (b) speed of the vehicle, (c) traffic conditions, (d) current wireless mobile network sources available, (e) anticipated wireless mobile network sources available along vehicle route, (f) signal strength of each wireless mobile network source available, or (g) time of day.
